(19) United States
(12) Patent Application Publication
(10) Pub. No.: US 2006/0152881 A1
(43) Pub. Date: Jul. 13, 2006

(54) Negative ion air purification and lighting device

(76) Inventor: Tsai-Feng Hou, Changhua City (TW)

Correspondence Address: TROXELL LAW OFFICE PLLC, SUITE 1404, 5205 LEESBURG PIKE, FALLS CHURCH, VA, 22041, US

(21) Appl. No.: 11/030,956

(22) Filed: Jan. 10, 2005

(51) Int. Cl. H01H 1/00

(52) U.S. Cl. 361/231

(57) ABSTRACT

A negative ion air purification and lighting device consisting of a negative ion generator disposed in between the tubular elements of an energy-saving light tube and, furthermore, a carbon fiber brush protruding from the negative ion generator. When the energy-saving light tube is switched on, a voltage amplification circuit is simultaneously enabled to output a high voltage of 2.5 kV at the tip of the carbon fiber brush—though the current is so minute that there is no danger to the human body. As a result, the ions in the high voltage are utilized to break down ions in the air into positive and negative ions. The heavier positive ions are absorbed by the carbon fiber brush and, furthermore, recycled as current via a wire, but the lighter negative ions are convected against dust sediment such that microscopic particulate, bacteria, and viruses cannot subsist in the air, thereby purifying indoor air, while the negative ions also have an invigorating effect on human body cells. As such, the present invention provides for the usage of an energy-saving light tube without at the same time occupying considerable space or ruining aesthetic appearance to effectively achieve air purification and physical health benefits.

### BACKGROUND OF THE INVENTION

1) Field of the Invention

The invention herein relates to a negative ion air purification and lighting device in which a negative ion generator is disposed at a suitable location of the socket in which an existent energy-saving light tube is mounted and, furthermore, a control circuit board draws electrical current directly from the said energy-saving light tube power supply, thereby ensuring both negative ion generator operation and illumination when the energy-saving light tube is switched on, while also providing for negative ion air purification and physical health benefits.

2) Description of the Prior Art

A conventional energy-saving light tube typically consists of several inverted U-shaped tubular elements that are mounted in a socket, with a control circuit board in the said socket that facilitates its switching on and off. Commonly observed in the form of a screw-in or 3U type, the said energy-saving light tube is superior to conventional fluorescent lights in terms of appearance and space utilization. As a result, consumers are content to use the said energy-saving light tube and, furthermore, the demand for them continues to rise daily.

### SUMMARY OF THE INVENTION

I. Problems to be Solved

1. The said energy-saving light tube can only be used for illumination and lacks any additional function. Since the sales price is expensive and its energy-saving value does not justify the said costly price, consumer use is attributed to their attractive appearance on lamp fixtures and, furthermore, because such lamp fixtures do not take up much space and thus do not encroach available area.

2. The said energy-saving light tube is expensively priced, only capable of providing illumination, and cannot accommodate any enhancement that would increase its added-value, which are significant shortcomings.

2. Means of Solution

1. A negative ion generator is disposed at a suitable location of the energy-saving light tube socket of the invention herein. While the energy-saving light tube is providing illumination and the negative ion generator converts alternating current to direct current, a voltage amplification circuit outputs a high voltage of 2.5 kV from the tip of a carbon fiber brush at the anterior extremity of the negative ion generator that separates positive and negative ions in the air, of which the negative ions released are convected for the purpose of air purification, the negative ions at the same time providing for physical health benefits by an invigorating effect on human body cells that has restorative applicability.

2. In the invention herein, the operation of the negative ion generator is ensured during the utilization of the energy-saving light tube and, furthermore, the purification of air when illumination is provided.

### BRIEF DESCRIPTION OF THE DRAWINGS

FIG. 1 is a cross-sectional drawing of the invention herein.

FIG. 1-A is a magnified drawing of the negative ion generator of the invention herein releasing negative ions from its tip.

FIG. 2 is an isometric drawing of negative ion, energy-saving light tube of the invention herein.

### DETAILED DESCRIPTION OF THE PREFERRED EMBODIMENTS

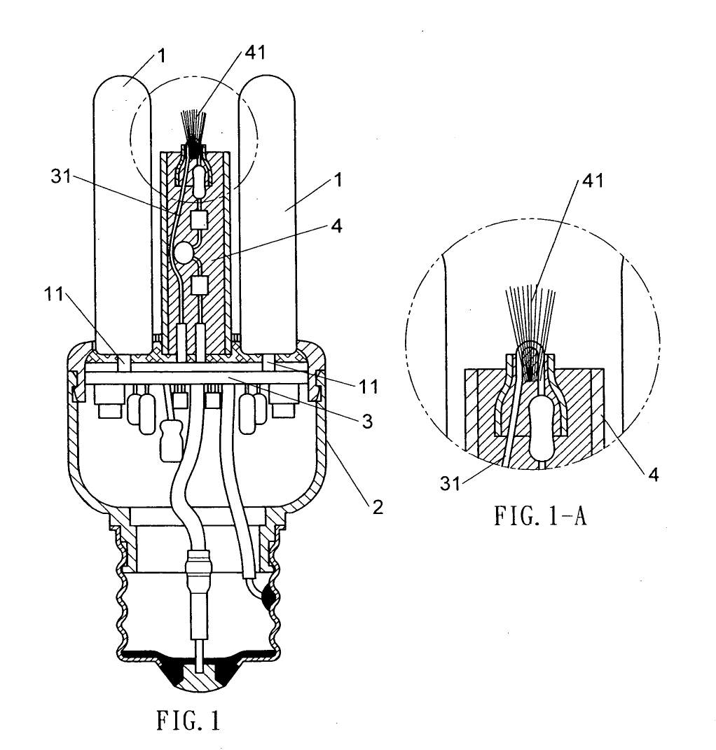

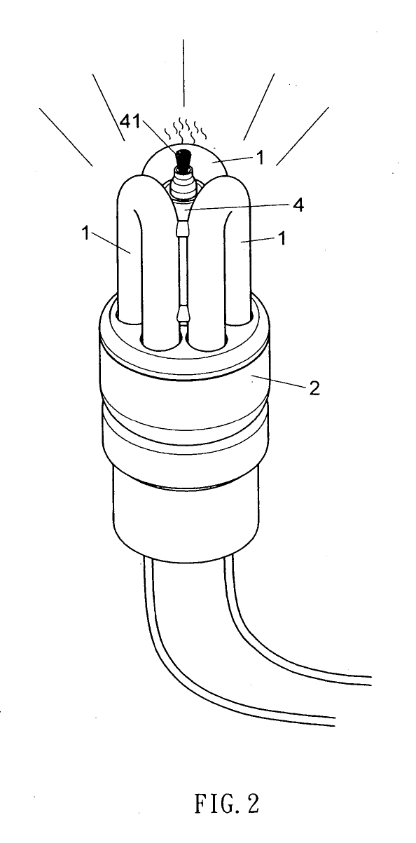

Referring to FIG. 1 and FIG. 1-A, the said energy-saving light tube 1 is mounted in the socket 2 and, furthermore, a control circuit board 3 is disposed at the bottom end of the energy-saving light tube 1, enabling the connection of the energy-saving light tube 1 pins 11 to the control circuit board 3 as well as the switching on and off of the energy-saving light tube 1 by the control circuit board 3 when power is supplied (the said control circuit board 3 is conventional and shall not be further elaborated); referring to FIG. 2, utilizing the power supply of the said energy-saving light tube 1 and making use of available space, a negative ion generator 4 with a carbon fiber brush 41 protruding from its anterior extremity is disposed at a suitable location in the area remaining between the said plurality of tubular elements comprising the energy-saving light tube 1 such that when the energy-saving light tube 1 is switched on, a voltage amplification circuit is simultaneously enabled and outputs a high voltage of 2.5 kV at the tip of the carbon fiber brush 41—though the current is so minute that there is no danger to the human body, the said high voltage breaking down ions in the air into positive and negative ions, wherein the heavier positive ions are absorbed by the carbon fiber brush 41 and, furthermore, recycled as current via a wire 31, but the lighter said negative ions are convected against dust sediment such that microscopic particulate, bacteria, and viruses cannot subsist in the air, thereby sanitizing indoor air, while the said negative ions also have an invigorating effect on human body cells that is restorative and, as such, the present invention provides for the usage of the energy-saving light tube 1 without at the same time occupying considerable space or ruining aesthetic appearance to effectively achieve air purification and physical health benefits.

As a result, since the integration of the negative ion generator 4 and energy-saving light tube 1 (can be a screw-in or a 3U type) of the invention herein does not affect the illumination function and, at the same time, the operation of the negative ion generator 4 operation is ensured when illumination is switched on and, furthermore, the external appearance of the energy-saving light tube 1 is unaffected but is capable of releasing negative ions that effectively purifies air, the present invention achieves the objectives of illumination, air sanitization, and attractive appearance, thereby providing for further added-value and practical utility.

1. A negative ion air purification and lighting device consisting of an energy-saving light tube mounted in a socket and, furthermore, a control circuit board disposed at the bottom end of the energy-saving light tube, enabling the connection of the pins of the said energy-saving light tube to the said control circuit board as well as the switching on and off of the said energy-saving light tube by the control said circuit board when power is supplied, the features of which are:
Utilizing the power supply of the said energy-saving light tube, a negative ion generator with a carbon fiber brush protruding from its anterior extremity is disposed at a suitable location in the area remaining between a plurality of said energy-saving light tubes such that switching on the said energy-saving light tube simultaneously enables a voltage amplification circuit to output a high voltage at the tip of the said carbon fiber brush that breaks down ions in the air into positive and negative ions, wherein the heavier positive ions are absorbed by the said carbon fiber brush and, furthermore, recycled as current via a wire, but the lighter said negative ions are convected and, as such, the present invention provides for the usage of the energy-saving light tube without occupying considerable space or ruining aesthetic appearance to effectively achieve air purification and physical health benefits.

2. As mentioned in claim 1 of the negative ion air purification and lighting device of the invention herein, the said negative ion generator can be integrated with different types of said energy-saving light tubes.
